(19) United States
(12) Patent Application Publication
(10) Pub. No.: US 2020/0272075 A1
(43) Pub. Date: Aug. 27, 2020

(54) FIXING DEVICE AND IMAGE FORMING APPARATUS

(71) Applicant: Konica Minolta, Inc., Tokyo (JP)

(72) Inventor: Hirotaka KANOU, Toyokawa-shi (JP)

(21) Appl. No.: 16/779,791

(22) Filed: Feb. 3, 2020

(30) Foreign Application Priority Data
Feb. 21, 2019 (JP) 2019-029179

(51) Int. Cl. G03G 15/20

(52) U.S. Cl. CPC G03G 15/2021; G03G 2215/2038; G03G 15/2064; G03G 15/2039

(57) ABSTRACT

A fixing device includes a fixing rotation body heated by a heat source, a pressure rotation body that comes into pressure contact with the fixing rotation body to form a nip, a cooling fan that blows cooling air toward any one rotation body of the fixing rotation body and the pressure rotation body, a duct that forms a flow area in which the cooling air is flowable so as to cool a non-passage area of a recording medium in the one rotation body, and a movable flow passage adjusting member that is disposed in the flow area and, while guiding the cooling air flowing through the flow area, adjusts a flow passage through which the cooling air flows.

The entire disclosure of Japanese Patent Application No. 2019-029179, filed on Feb. 21, 2019, is incorporated herein by reference in its entirety.

### BACKGROUND

### Technological Field

The present invention relates to a fixing device and an image forming apparatus.

### Description of the Related Art

A conventional image forming apparatus includes a fixing device for fixing a toner image transferred to a recording medium onto the recording medium.

The fixing device includes a fixing belt (fixing rotation body) and a pressure roller that is brought into pressure contact with the fixing belt to form a nip. The fixing belt is heated by a heat source, so that the toner image transferred to the recording medium is fused to be fixed.

Although the image forming apparatus transports recording media of various sizes and form images, when the images are continuously formed on small-sized recording media, the temperature of a non-passage area, through which the recording media do not pass, may rise in the fixing belt to exceed the heatproof temperature of the fixing belt.

Thus, Japanese Laid-Open Patent Publication No. 2014-71234 and Japanese Laid-Open Patent Publication No. 2008-52031 propose various techniques of cooling a fixing belt.

The fixing device disclosed in Japanese Laid-Open Patent Publication No. 2014-71234 includes means for variably cooling a cooling area of a fixing rotation body and a plurality of temperature detection means. This fixing device alternately switches per predetermined period of time between an entirely cooling mode of cooling the entire non-passage area and a locally cooling mode of cooling an area including a high-temperature spot in the non-passage area.

The fixing device disclosed in Japanese Laid-Open Patent Publication No. 2008-52031 moves a fan and a duct that guides cooling air blown from the fan toward the fixing rotation body, thereby changing a cooling range.

### SUMMARY

However, it cannot be said that the fixing device disclosed in Japanese Laid-Open Patent Publication No. 2014-71234, which alternately switches between the entirely cooling mode and the locally cooling mode, efficiently cools the fixing belt. Also, the fixing device moves a shielding plate in a direction orthogonal to the direction in which cooling air is blown to shield part of the cooling air, thereby changing the cooling range. This may increase a pressure loss, and temperature ripples may occur due to an effect of an operation time of the shielding plate in switching between the modes.

The fixing device disclosed in Japanese Laid-Open Patent Publication No. 2008-52031 is configured to move the fan and the duct, and accordingly has a large-scale, complicated device configuration.

The present invention has been made in view of the above problem, and an object of the present invention is to provide a fixing device and an image forming apparatus that have a simple configuration and, while increasing cooling efficiency, can adjust the temperature of a non-passage area, through which a recording medium does not pass, in a rotation body forming a nip.

To achieve at least one of the abovementioned objects, according to an aspect of the present invention, a fixing device reflecting one aspect of the present invention comprises: a fixing rotation body heated by a heat source; a pressure rotation body that comes into pressure contact with the fixing rotation body to form a nip; a fan that blows cooling air toward any one rotation body of the fixing rotation body and the pressure rotation body; a duct that forms a flow area in which the cooling air is flowable so as to cool a non-passage area of a recording medium in the one rotation body; and a movable flow passage adjusting member that is disposed in the flow area and, while guiding the cooling air flowing through the flow area, adjusts a flow passage through which the cooling air flows.

To achieve at least one of the abovementioned objects, according to an aspect of the present invention, an image forming apparatus reflecting one aspect of the present invention comprises: an image forming device that forms a toner image on a recording medium transported along a transport path; and the fixing device that fixes the toner image onto the recording medium transported along the transport path.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a schematic diagram showing an image forming apparatus according to Embodiment 1.

FIG. 2 is a schematic sectional diagram showing a fixing device according to Embodiment 1.

FIG. 3 shows a first state of the fixing device according to Embodiment 1.

FIG. 4 shows a second state of the fixing device according to Embodiment 1.

FIG. 5 shows a third state of the fixing device according to Embodiment 1.

FIG. 6 shows a fourth state of the fixing device according to Embodiment 1.

FIG. 7 shows the magnitude of various parameters in the first state to the fourth state of the fixing device according to Embodiment 1.

FIG. 8 shows a shape of a second swing member according to Embodiment 1.

FIG. 9 shows an air volume distribution of cooling air flowing through a non-passage area on the rotary roller side in a fixing device of each of an example and a comparative example.

FIG. 10 shows a temperature distribution in the width direction of a fixing belt in the fixing device of each of the example and the comparative example.

FIG. 11 shows a first state of a fixing device according to Embodiment 2.

FIG. 12 shows a second state of the fixing device according to Embodiment 2.

FIG. 13 shows a second swing member and a pressure roller for a fixing device according to Embodiment 3.

FIG. 14 shows a first state of a fixing device according to Embodiment 4.

FIG. 15 shows a second state of the fixing device according to Embodiment 4.

### DETAILED DESCRIPTION OF EMBODIMENTS

Hereinafter, one or more embodiments of the present invention will be described with reference to the drawings. However, the scope of the invention is not limited to the disclosed embodiments.

In the embodiments below, the same or common parts are denoted by the same references, description of which will not be repeated.

### Embodiment 1

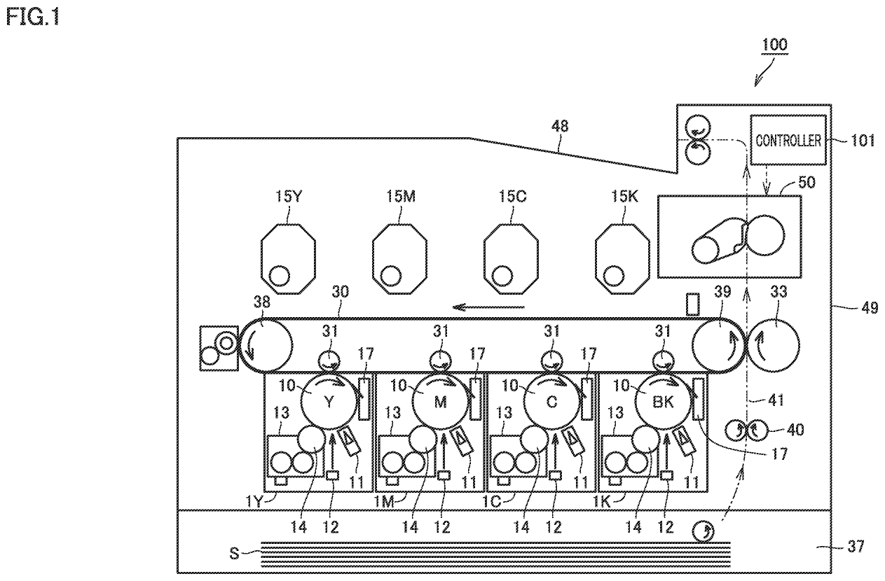

FIG. 1 is a schematic diagram showing an image forming apparatus according to Embodiment 1. An image forming apparatus 100 according to Embodiment 1 will be described with reference to FIG. 1.

FIG. 1 shows image forming apparatus 100 as a color printer. Although description will be given of image forming apparatus 100 as a color printer, image forming apparatus 100 is not limited to a color printer. For example, image forming apparatus 100 may be a monochrome printer, a facsimile machine, or a multi-functional peripheral (MFP) including a monochrome printer, a color printer, and a facsimile machine.

Image forming apparatus 100 includes image forming units 1Y, 1M, 1C, and 1K, an intermediate transfer belt 30, primary transfer rollers 31, a secondary transfer roller 33, a cassette 37, a driven roller 38, a driving roller 39, a timing roller 40, a fixing device 50, a housing 49, and a controller 101.

Housing 49 forms an outer shell of image forming apparatus 100. Housing 49 accommodates image forming units 1Y, 1M, 1C, and 1K, intermediate transfer belt 30, primary transfer rollers 31, secondary transfer roller 33, cassette 37, driven roller 38, driving roller 39, timing roller 40, fixing device 50, and controller 101.

Image forming units 1Y, 1M, 1C, and 1K, intermediate transfer belt 30, primary transfer rollers 31, secondary transfer roller 33, cassette 37, driven roller 38, driving roller 39, and timing roller 40 constitute an image forming device. The image forming device forms a toner image on a sheet of paper S as a recording medium transported along a transport path 41, which will be described below.

Image forming units 1Y, 1M, 1C, and 1K are arranged sequentially along intermediate transfer belt 30. Image forming unit 1Y is supplied with toner from a toner bottle 15Y to form a yellow (Y) toner image T. Image forming unit 1M is supplied with toner from a toner bottle 15M to form a magenta (M) toner image T. Image forming unit 1C is supplied with toner from a toner bottle 15C to form a cyan (C) toner image T. Image forming unit 1K is supplied with toner from a toner bottle 15K to form a black (BK) toner image T.

Image forming units 1Y, 1M, 1C, and 1K are arranged sequentially in the direction of rotation of intermediate transfer belt 30 along intermediate transfer belt 30. Image forming units 1Y, 1M, 1C, and 1K each include a photoconductor 10, a charging device 11, an exposing device 12, a developing device 13, and a cleaning device 17.

Charging device 11 charges the surface of photoconductor 10 uniformly. Exposing device 12 irradiates photoconductor 10 with laser light in response to a control signal from controller 101, thereby exposing the surface of photoconductor 10 to light in accordance with an input image pattern. An electrostatic latent image corresponding to the input image is thus formed on photoconductor 10.

Developing device 13 applies a developing bias to a developing roller 14 while rotating developing roller 14, thus causing the toner to adhere to the surface of developing roller 14. Consequently, the toner is transferred from developing roller 14 to photoconductor 10, so that a toner image T corresponding to the electrostatic latent image is developed on the surface of photoconductor 10.

Photoconductor 10 and intermediate transfer belt 30 are in contact with each other at a position at which primary transfer roller 31 is provided. Primary transfer roller 31 has a roller shape and is configured to be rotatable. A transfer voltage of the polarity opposite to that of toner image T is applied to primary transfer roller 31, causing toner image T to be transferred from photoconductor 10 to intermediate transfer belt 30. Yellow (Y) toner image T, magenta (M) toner image T, cyan (C) toner image T, and black (BK) toner image T are sequentially overlaid on one another to be transferred from photoconductor 10 to intermediate transfer belt 30. Consequently, a color toner image T is formed on intermediate transfer belt 30.

Intermediate transfer belt 30 is laid across driven roller 38 and driving roller 39. Driving roller 39 is drivingly rotated by, for example, a motor (not shown). Intermediate transfer belt 30 and driven roller 38 rotate along with driving roller 39. Consequently, toner image T on intermediate transfer belt 30 is transported to secondary transfer roller 33.

Cleaning device 17 is in pressure contact with photoconductor 10. Cleaning device 17 collects the toner remaining on the surface of photoconductor 10 after the transfer of toner image T.

Sheets of paper S are placed in cassette 37. Sheets of paper S are transported one by one from cassette 37 along transport path 41 to secondary transfer roller 33 by timing roller 40. Secondary transfer roller 33 has a roller shape and is configured to be rotatable. Secondary transfer roller 33 applies a transfer voltage of the polarity opposite to that of toner image T to sheet of paper S being transported. This causes toner image T to be attracted from intermediate transfer belt 30 to secondary transfer roller 33, so that toner image T on intermediate transfer belt 30 is transferred onto sheet of paper S. Thus, primary transfer rollers 31, intermediate transfer belt 30, and secondary transfer roller 33 correspond to a transfer unit that transfers toner image T from photoconductor 10 to sheet of paper S.

A timing at which sheet of paper S is transported to secondary transfer roller 33 is adjusted by timing roller 40 in accordance with the position of toner image T on intermediate transfer belt 30. Timing roller 40 allows toner image T on intermediate transfer belt 30 to be transferred to an appropriate position on sheet of paper S.

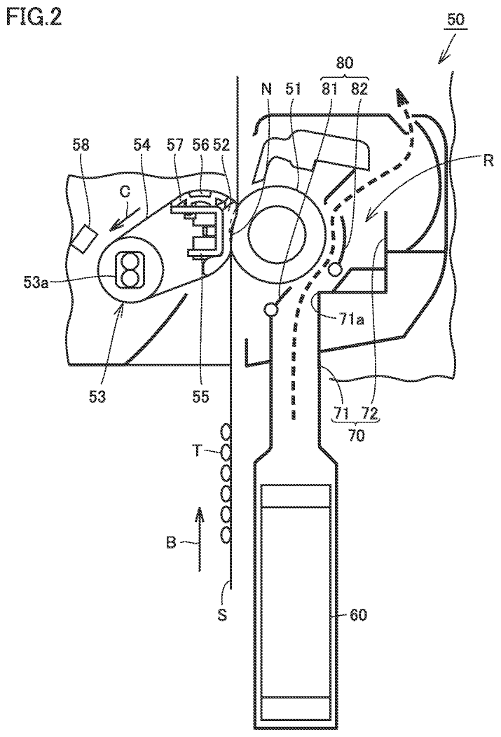

Fixing device 50 pressurizes and heats sheet of paper S passing therethrough. Toner image T (see FIG. 2) is accordingly fixed onto sheet of paper S. In this manner, fixing device 50 fixes the toner image on sheet of paper S transported along transport path 41. Sheet of paper S with toner image T fixed thereon is ejected onto a tray 48.

Although image forming apparatus 100 employing a tandem system as a printing system has been described above, the printing system of image forming apparatus 100 is not limited to the tandem system. The arrangement of the components in image forming apparatus 100 can be changed appropriately in accordance with the printing system employed. The printing system of image forming apparatus 100 may be a rotary system or a direct transfer system. In the case of the rotary system, image forming apparatus 100 is composed of one photoconductor 10, and a plurality of developing devices 13 configured to be rotatable on the same axis. In printing, image forming apparatus 100 guides developing devices 13 sequentially to photoconductor 10 to develop toner images T of the respective colors. In the case of the direct transfer system, image forming apparatus 100 directly transfers toner image T formed on photoconductor 10 to sheet of paper S.

FIG. 2 is a schematic sectional diagram showing the fixing device according to the embodiment. Fixing device 50 will be described with reference to FIG. 2.

Fixing device 50 includes a pressure roller 51 as a pressure rotation body, a pad member 52, a heating roller 53 as a heating member, a fixing belt 54 as a fixing rotation body, a fixing member 55, a lubricant application unit 56, a holding member 57, and a temperature sensor 58.

Pressure roller 51 is disposed outside of fixing belt 54. Pressure roller 51 faces pad member 52. Pressure roller 51 retains fixing belt 54 between pad member 52 and pressure roller 51 and heats fixing belt 54. Thus, fixing belt 54 is pressed. In other words, pressure roller 51 brings fixing belt 54 into pressure contact therewith to form a nip N to which the recording medium is transported. Pressure roller 51 rotates by the torque from the drive source. Fixing belt 54 rotates along with the rotation of pressure roller 51. The rotation of pressure roller 51 causes fixing belt 54 to rotate in a direction opposite to the direction of rotation of pressure roller 51.

Pressure roller 51 is formed of, for example, a cored bar, a surface layer, and a release layer. The cored bar is made of aluminum or iron and has a pipe shape. The surface layer is an elastic layer of, for example, silicone rubber. The release layer is provided to cover the surface layer. The release layer is made of, for example, perfluoroalkoxy polymer (PFA).

Pad member 52 is disposed inside of fixing belt 54. Pad member 52 is disposed to face pressure roller 51 with fixing belt 54 therebetween. Pad member 52 has a curved surface that gradually projects toward pressure roller 51 as it advances downstream in the transport direction of sheet of paper S, that is, as closer to an exit of nip N. Pad member 52 is made of a heat-resistant resin, such as polyphenylene sulfide, polyimide, or liquid crystal polymer.

Although pad member 52 is distorted by pressure, the bending distortion thereof is restrained through fixing by high-strength fixing member 55.

Heating roller 53 is disposed inside of fixing belt 54. Heating roller 53 has a heating source 53a therein. Heating source 53a heats fixing belt 54. Heating source 53a is controlled such that the surface of fixing belt 54 has a predetermined constant temperature.

Heating source 53a is, for example, a halogen lamp. The halogen lamp includes a plurality of light sources that perform different light distributions. The energization is switched among the plurality of light sources in accordance with the size of a recording medium.

Heating source 53a may be one that performs induction heating (IH) of fixing belt 54, one that generates heat using fixing belt 54 as a resistance heating element, in addition to the halogen lamp.

Heating roller 53 has a cylindrical shape and is made of a metal such as aluminum or stainless steel (SUS). When a halogen lamp is used as heating source 53a, heating roller 53 preferably has a black inner circumferential surface. In order to prevent a flaw on the outer surface due to foreign matter or the like, the outer circumferential surface of heating roller 53 may be coated with polytetrafluoroethylene (PTFE) or the like.

Fixing belt 54 is provided as an endless belt. Fixing belt 54 is rotatably laid across pad member 52 and heating roller 53. Fixing belt 54 includes a base layer, an elastic layer, and a release layer.

Although the outside diameter of the fixing belt is of any size, it is preferably 10 mm or more and 100 mm or less, is preferably approximately 40 mm. The base layer is preferably made of polyimide, SUS, or electroformed nickel. The thickness of the base layer is preferably 50 μm or more and 70 μm or less. The elastic layer is preferably made of a material having high heat resistance, such as silicone rubber or fluororubber. The thickness of the elastic layer is preferably 120 μm or more and 190 μm or less. The release layer preferably has a configuration provided with releasing performance, for example, fluororesin or fluorinated coating. The thickness of the release layer is preferably 17 μm or more and 19 μm or less.

Pad member 52 and holding member 57 are fixed to fixing member 55. Fixing member 55 has a square U-shape as viewed in the width direction of fixing belt 54 (the direction perpendicular to the sheet of paper of FIG. 2). Fixing member 55 is disposed such that its U-shaped leading end side is directed to heating roller 53. Pad member 52 is fixed to the portion of fixing member 55 which faces pressure roller 51. Holding member 57 is fixed to the downstream portion of fixing member 55 in the transport direction of sheet of paper S (the direction of an arrow B in FIG. 2).

Lubricant application unit 56 is disposed to come into contact with the inner circumferential surface of fixing belt 54. Lubricant application unit 56 is disposed downstream of pad member 52 and upstream of heating roller 53 in the direction of rotation of the fixing belt (the direction of an arrow C in FIG. 2).

Lubricant application unit 56 has a function to hold a lubricant and applies the lubricant to the inner circumferential surface of fixing belt 54. The lubricant may be a silicon-based lubricant having high heat resistance or a fluorine-based lubricant. Lubricant application unit 56 may be, for example, a fibrous member having high heat resistance, such as aramid fiber or fluorine fiber, a highly porous member, such as silicon sponge, and a felt member. Note that lubricant application unit 56 is not limited to the above members, and may be a rigid chromium-plated layer or a plated layer obtained by dispersion of a fluorine resin in a nickel plating liquid and simultaneous precipitation.

Fixing belt 54 which passes through nip N toward heating roller 53 is wound around holding member 57. Holding member 57 holds lubricant application unit 56.

Temperature sensor 58 measures the temperature of fixing belt 54. Temperature sensor 58 is a highly responsive sensor of infrared detection system, for example, a thermopile. This achieves high detection accuracy. Two or more temperature sensors 58 are disposed to measure the temperature of the passage area through which the recording medium passes and the temperature of the non-passage area through which the recording medium does not pass in fixing belt 54. The non-passage area is formed on the opposite sides of the passage area in the width direction of the fixing belt.

Fixing device 50 further includes a fan 60, a duct 70, and a flow passage adjusting member 80 in order to cool the non-passage area in fixing belt 54. The non-passage area of fixing belt 54 is cooled through absorption of heat from the non-passage area of pressure roller 51 cooled as described below.

Fan 60 blows cooling air toward pressure roller 51. Fan 60 is disposed to face each of the opposite ends in the axial direction of pressure roller 51. Fan 60 may be, for example, a sirocco fan. Fan 60 may be an axial-flow fan or a cross-flow fan.

Duct 70 forms a flow area R in which the cooling air blown from fan 60 is flowable in order to cool the non-passage area of pressure roller 51. Duct 70 is disposed at each of the opposite ends in the axial direction of pressure roller 51. Duct 70 includes a first duct portion 71 and a second duct portion 72.

First duct portion 71 is a duct for blowing the cooling air from fan 60 to the non-passage area of pressure roller 51. First duct portion 71 has an outlet 71a facing the non-passage area. The cooling air is blown from outlet 71a toward the non-passage area.

Second duct portion 72 is a duct for causing the cooling air to flow along part of the circumference of pressure roller 51 in the non-passage area. Second duct portion 72 is provided to cover part of the circumference of pressure roller 51.

Flow passage adjusting member 80 is disposed in flow area R. Flow passage adjusting member 80 adjusts, while guiding the cooling air flowing through flow area R, the flow passage through which the cooling air flows. Flow passage adjusting member 80 includes a first swing member 81 and a second swing member 82.

First swing member 81 is provided in first duct portion 71. Specifically, first swing member 81 is provided at the leading end of first duct portion 71.

First swing member 81 has the shape of a plate that bends toward the central axis of first duct portion 71 as approaching downstream in the air blow direction in which the cooling air is blown. Note that first swing member 81 may have a shape inclined toward the central axis of first duct portion 71 as approaching downstream of the air outlet. Such a shape can guide the cooling air while reducing a pressure loss of the cooling air.

First swing member 81 includes a base end located upstream in the air blow direction in which the cooling air is blown and a leading end located downstream in the air blow direction. First swing member 81 may be, for example, a louver.

First swing member 81 is configured to swing toward or away from pressure roller 51. Specifically, first swing member 81 is fixed on the leading end side and swings such that the leading end side moves toward or away from pressure roller 51 with the fixed end on the base end side as a fulcrum. First swing member 81 is preferably provided so as to swing continuously. Also, first swing member 81 is preferably provided to stop at a desired position within the swing range.

Second swing member 82 is provided in second duct portion 72. Specifically, second swing member 82 is provided inside of second duct portion 72.

Second swing member 82 has the shape of a plate that bends toward pressure roller 51 as approaching downstream in the air blow direction. Second swing member 82 includes a base end located upstream in the air blow direction in which the cooling air is blown and a leading end located downstream in the air blow direction. Second swing member 82 may be, for example, a louver.

Second swing member 82 is configured to swing toward or away from pressure roller 51. Specifically, second swing member 82 is fixed on the base end side and swings such that the leading end side moves toward or away from pressure roller 51 with the fixed end on the base end side as a fulcrum. Second swing member 82 is preferably provided to swing continuously. Also, second swing member 82 is preferably provided to stop at a desired position within the swing range.

The positions of first swing member 81 and second swing member 82 are adjusted by moving first swing member 81 and second swing member 82, so that a flow passage through which the cooling air flows can be adjusted as indicated by the broken line. Controller 101 may control the operations of first swing member 81 and second swing member 82 based on the results measured by temperature sensor 58.

Controller 101 may control the operations of first swing member 81 and second swing member 82 based on information on a recording medium, such as the thickness of the recording medium, the size of the recording medium, and/or the velocity of transportation of the recording medium. Note that controller 101 controls a drive source (not shown) for driving first swing member 81 and second swing member 82, such as a motor, thereby controlling the operations of first swing member 81 and second swing member 82.

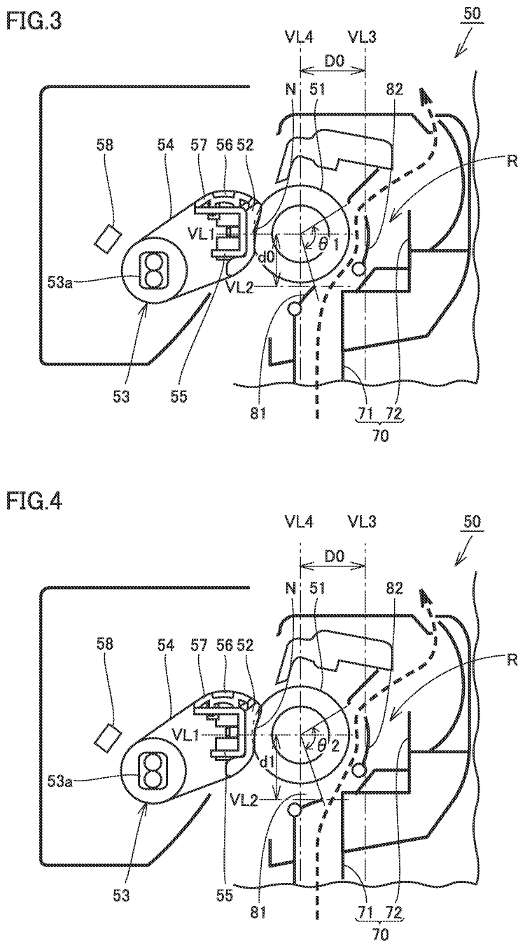

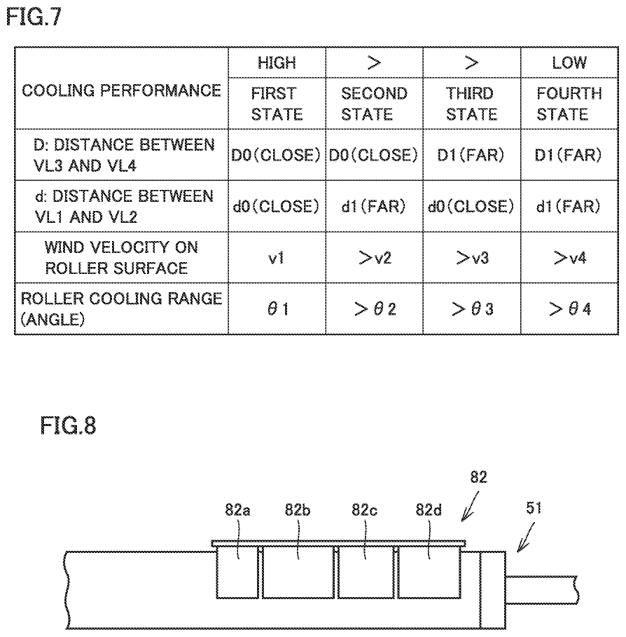

FIGS. 3 to 6 show a first state to a fourth state of the fixing device according to Embodiment 1. FIG. 7 shows the magnitude of various parameters in the first state to the fourth state of the fixing device according to Embodiment 1. The first state to the fourth state of fixing device 50 will be described with reference to FIGS. 3 to 7.

In the first state to the fourth state, first swing member 81 is located at a first position or a second position, and second swing member 82 is located at a third position or a fourth position.

As shown in FIGS. 3 and 5, the first position is a position at which the distance between a virtual line VL2, which passes through the leading end of first swing member 81, and a virtual line VL1, which is parallel to virtual line VL2 and passes through the center of pressure roller 51, is d0 as fixing device 50 is viewed along the axis of rotation of pressure roller 51. Virtual line VL1 and virtual line VL2 are, for example, parallel to the horizontal direction.

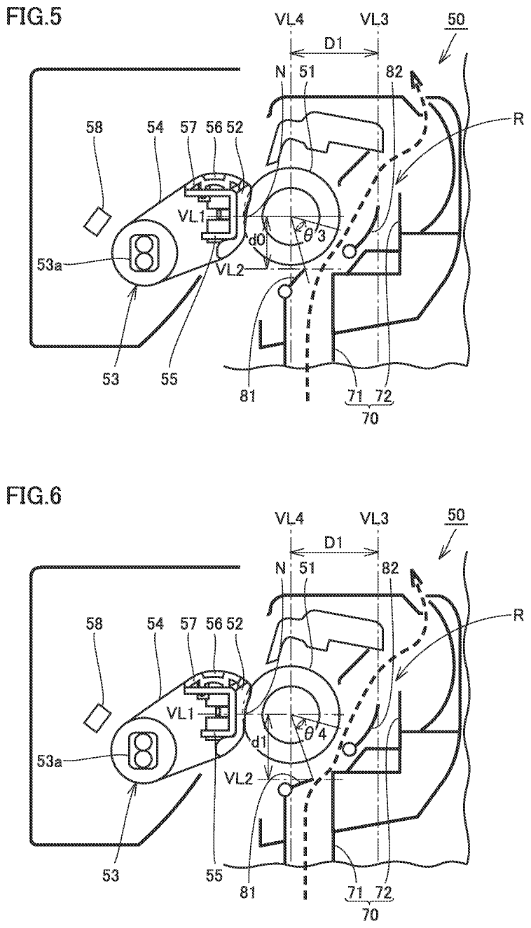

The second position is a position at which the distance between virtual line VL2, which passes through the leading end of first swing member 81, and virtual line VL1, which is parallel to virtual line VL2 and passes through the center of pressure roller 51, is dl as shown in FIGS. 4 and 6, where dl is greater than d0.

The third position is a position at which the distance between a virtual line VL3, which passes through the leading end of second swing member 82, and a virtual line VL4, which is parallel to virtual line VL3 and passes through the center of pressure roller 51, is D0 as fixing device 50 is viewed along the axis of rotation of pressure roller 51 as shown in FIGS. 3 and 5. Virtual line VL3 and virtual line VL4 are, for example, parallel to the up-down direction.

The fourth position is a position at which the distance between virtual line VL3, which passes through the leading end of second swing member 82, and virtual line VL4, which is parallel to virtual line VL3 and passes through the center of pressure roller 51, is D1 as fixing device 50 is viewed along the axis of rotation of pressure roller 51 as shown in FIGS. 4 and 6, where D1 is greater than D0.

As shown in FIG. 3, in the first state, first swing member 81 is positioned at the first position close to pressure roller 51, and second swing member 82 is positioned at the fourth position close to pressure roller 51.

In this case, as first swing member 81 and second swing member 82 move toward pressure roller 51, the range of the cooling air flowing along the circumferential surface of pressure roller 51 in the non-passage area (cooling range of pressure roller 51) increases. In other words, the central angle of the circumferential surface of pressure roller 51 along which the cooling air flows is an angle θ1.

As shown in FIG. 4, in the second state, first swing member 81 is positioned at the third position apart from pressure roller 51, and second swing member 82 is positioned at the second position close to pressure roller 51.

In this case, as first swing member 81 is farther from pressure roller 51 than in the first state, the cooling air flows away from the circumferential surface of pressure roller 51 near the outlet. Thus, the range of the cooling air flowing along the circumferential surface of pressure roller 51 in the non-passage area is smaller than in the first state. In other words, a central angle θ2 of the circumferential surface of pressure roller 51 along which cooling air flows is smaller than θ1.

As shown in FIG. 5, in the third state, first swing member 81 is located at the first position close to pressure roller 51, and second swing member 82 is located at the fourth position apart from pressure roller 51.

In this case, second swing member 82 is farther from pressure roller 51 though first swing member 81 is closer to pressure roller 51 than in the second state. This widens the flow passage on the second duct portion 72 side, allowing the cooling air to easily flow away from the circumferential surface of pressure roller 51.

Thus, the range of the cooling air flowing along the circumferential surface of pressure roller 51 in the non-passage area is much smaller than in the second state. In other words, a central angle θ3 of the circumferential surface of pressure roller 51 along which the cooling air flows is smaller than θ2.

As shown in FIG. 6, in the fourth state, first swing member 81 is located at the second position apart from pressure roller 51, and second swing member 82 is located at the fourth position apart from pressure roller 51.

In this case, as first swing member 81 is farther from pressure roller 51 than in the third state, the cooling air flows away from the circumferential surface of pressure roller 51 near the outlet. Thus, the range of the cooling air flowing along the circumferential surface of pressure roller 51 in the non-passage area is much smaller than in the third state. In other words, a central angle θ4 of the inner circumferential surface of pressure roller 51 along which the cooling air flows is smaller than θ3.

As described above, the cooling range of pressure roller 51 and the velocity of cooling air on the surface of pressure roller 51 can be adjusted appropriately as shown in FIG. 7 by adjusting the positions of first swing member 81 and second swing member 82 as in the first state to the fourth state. This enables adjustment of the cooling performance.

Specifically, the cooling range of pressure roller 51, that is, a central angle θn (n is an integer from one to four) becomes smaller from the first state to the fourth state. A velocity Vn (n is an integer from one to four) of the cooling air on the surface of pressure roller 51 also becomes smaller from the first state to the fourth state. Along with this, the cooling performance becomes lower from the first state to the fourth state.

V1 is the velocity of the cooling air on the surface of pressure roller 51 in the first state. V2 is the velocity of the cooling air on the surface of pressure roller 51 in the second state. V3 is the velocity of the cooling air on the surface of pressure roller 51 in the third state. V4 is the velocity of the cooling air on the surface of pressure roller 51 in the fourth state.

When the wind velocity of the cooling air blown from fan 60 is set to, for example, 4 m/s, D0, D1, d0, and dl are preferably approximately 2 mm to approximately 8 mm.

FIG. 8 shows the shape of the second swing member according to Embodiment 1. Second swing member 82 will be described in detail with reference to FIG. 8.

As shown in FIG. 8, second swing member 82 has a plurality of divided portions 82a, 82b, 82c, and 82d divided in the direction parallel to the axis of rotation of pressure roller 51. Each of divided portions 82a, 82b, 82c, and 82d is provided so as to swing independently.

Divided portions 82a, 82b, 82c, and 82d divided in the direction parallel to the axis of rotation may have different lengths.

Although Embodiment 1 has described the case in which second swing member 82 has a plurality of divided portions by way of example, the present invention is not limited thereto. Second swing member 82 may not be divided or may be divided into two or more divided portions, not limited to four portions.

When second swing member 82 is divided into a plurality of portions, the velocity, flow passage, or the like of cooling air can also be adjusted also in the direction parallel to the axis of rotation by adjusting the positions of divided portions 82a, 82b, 82c, and 82d. Thus, the air volume of cooling air can be adjusted such that, in the non-passage area, the air volume of the cooling air cooling a high-temperature area in which the temperature is higher is larger than the air volume of the cooling air cooling a low-temperature area in which the temperature is lower than that of the high-temperature area.

As described above, in Embodiment 1, in order to cool the non-passage area in pressure roller 51, a movable flow passage adjusting member that adjusts the flow passage of the cooling air while guiding the cooling air is provided in the flow area which is formed by duct 70 and through which the cooling air is flowable.

The flow passage can be adjusted by using a plate-shaped member that can swing, such as first swing member 81 and second swing member 82, as the flow passage adjusting member, leading to a simple configuration.

The flow passage adjusting member, which has a shape to guide the cooling air, can have a small pressure loss of the cooling air compared with the structure that shields the cooling air in the direction orthogonal to the air blow direction. This leads to a higher degree of cooling efficiency. Further, the range, wind velocity, or the like of the cooling air flowing along the circumferential surface of pressure roller 51 can be appropriately adjusted as described above by adjusting the flow passage, thereby adjusting the temperature of the non-passage area. Consequently, for example, printing can be performed at higher speed, or a recording medium can be transported and printed at lower speed, without increasing the size of the fan.

Further, the temperature of the non-passage area in fixing belt 54 varies depending on the size of the recording medium, and also, the temperature distribution of the non-passage area in the width direction varies. Controller 101 can thus adjust the operation of the flow passage adjusting member based on at least the information on the size of the recording medium, thereby reducing a temperature difference between the highest-temperature portion and the lowest-temperature portion in the temperature distribution of the non-passage area.

The temperature of the non-passage area in fixing belt 54 also varies depending on the information on the recording medium, such as the basis weight, type, or transport velocity of the recording medium, in addition to the size of the recording medium. Controller 101 thus may adjust the operation of the flow passage adjusting member based on various information on the recording medium.

Various information on the recording medium may be input from an input portion provided in the housing, or may be obtained from various sensors.

Also, variations in the temperature in the non-passage area can be reduced by providing divided portions 82a, 82b, 82c, and 82d and adjusting the velocity, flow passage, or the like of the cooling air also in the direction parallel to the axis of rotation in accordance with the temperature distribution of the non-passage area.

### Verification Experiments

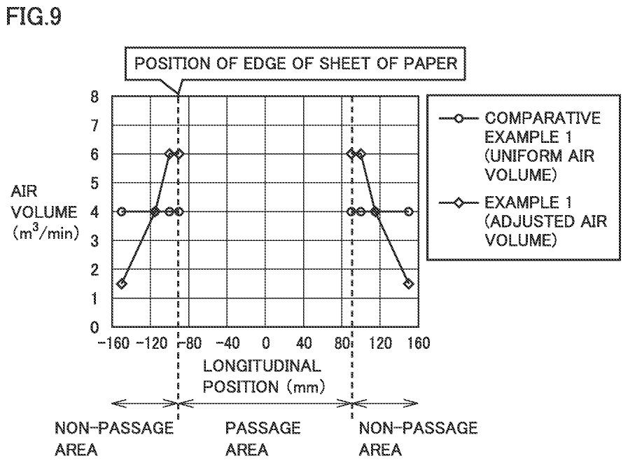

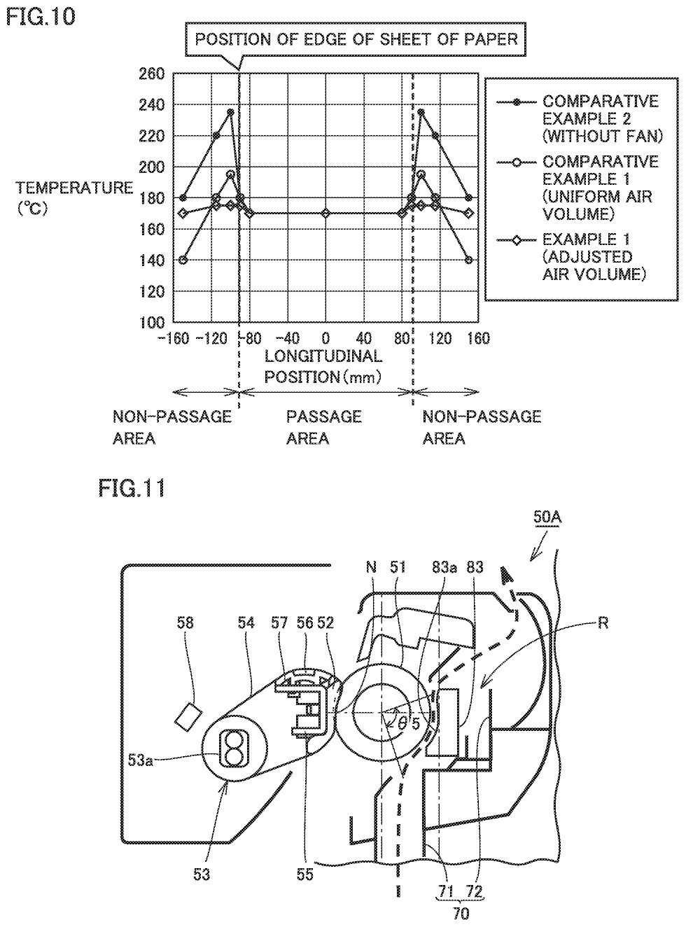

FIG. 9 shows an air volume distribution of the cooling air flowing through a non-passage area on the rotary roller side in a fixing device in each of an example and a comparative example. FIG. 10 shows a temperature distribution in the width direction of a fixing belt in the fixing device in each of the example and the comparative example. The verification experiments conducted for confirming the effects of the embodiment will be described with reference to FIGS. 9 and 10.

As shown in FIGS. 9 and 10, fixing device 50 according to Embodiment 1 was used as Example 1. A fixing device including no first swing member 81 and no second swing member 82 serving as the flow passage adjusting member was used as Comparative Example 1, unlike fixing device 50 according to Embodiment 1. A fixing device including no fan 60, no first swing member 81, and no second swing member 82 was used as Comparative Example 2, unlike fixing device 50 according to Embodiment 1.

In Example 1 and Comparative Example 1 in which cooling air was blown, the air volume distribution of the cooling air passing through the surface of pressure roller 51 in the non-passage area was measured, and also, the temperature distribution in the width direction of fixing belt 54 was measured. In Comparative Example 2, since the cooling air was not blown, the temperature distribution in the width direction of fixing belt 54 was measured. In measurement of the temperature distribution in the width direction of fixing belt 54, a predetermined number of B5 paper were printed.

In Example 1 and Comparative Example 1 in which cooling air was blown, the results as shown in FIG. 9 were obtained for the air volume distribution of the cooling air passing through the surface of pressure roller 51 in the non-passage area.

Specifically, in Comparative Example 1, since no flow passage adjusting member was provided, the cooling air was blown uniquely to the surface of pressure roller 51 in the non-passage area in the direction of the axis of rotation. Consequently, the air volume distribution of the cooling air on the surface of pressure roller 51 in the non-passage area was substantially uniform in the direction of the axis of rotation, approximately 4 m³/min.

In Example 1, the positions of first swing member 81 and second swing member 82 were controlled to adjust the flow passage of the cooling air, thereby adjusting the air volume distribution of cooling air passing through the surface of pressure roller 51 in the non-passage area. Specifically, an adjustment was made such that, in the non-passage area, the air volume of the cooling air cooling a high-temperature area having a higher temperature was larger than the air volume of the cooling air cooling a low-temperature area having a temperature lower than that of the high-temperature area. More specifically, in control of the positions of first swing member 81 and second swing member 82 in Example 1, divided portions 82a and 82b in second swing member 82 are made closer to pressure roller 51 side than divided portions 82c and 82d are to pressure roller 51 side.

Consequently, a velocity distribution in which an air volume became smaller as closer to the outside in the direction of the axis of rotation in the non-passage area was obtained in Example 1. Specifically, velocity was approximately 6 m³/min near the boundary between the passage area and the non-passage area, approximately 4 m³/min at substantially the central portion of the non-passage area, and approximately 1.5 m³/min on the outer end side of the non-passage area.

The temperature distribution in the width direction of fixing belt 54 in the fixing device in each of Example 1, Comparative Example 1, and Comparative Example 2 was as shown in FIG. 10.

Specifically, in Comparative Example 2, since the cooling air was not blown, such a temperature distribution was obtained that temperature was higher near the boundary between the passage area and the non-passage area and decreased toward the outside.

In Comparative Example 1, since the cooling air was blown uniquely to the non-passage area, the temperature of the non-passage area decreased substantially uniformly overall, compared with Comparative Example 2. This causes a portion cooled excessively in the non-heating portion of fixing belt 54.

In Example 1, an air volume was adjusted such that, in the non-passage area, the air volume of the cooling air cooling the high-temperature area having a higher temperature was larger than the air volume of the cooling air cooling the low-temperature area having a temperature lower than that of the high-temperature area. As a result, the temperature of the non-passage area was substantially uniform in the width direction.

As described above, it was also confirmed experimentally that the temperature of the non-passage area was successfully adjusted by adjusting the flow passage through which cooling air flowed using the flow passage adjusting member. In particular, it was confirmed that variations in the temperature in the non-passage area was successfully reduced by adjusting an air volume using the flow passage adjusting member to be larger than the air volume of the cooling air cooling the low-temperature area having a temperature lower than that of the high-temperature area.

### Embodiment 2

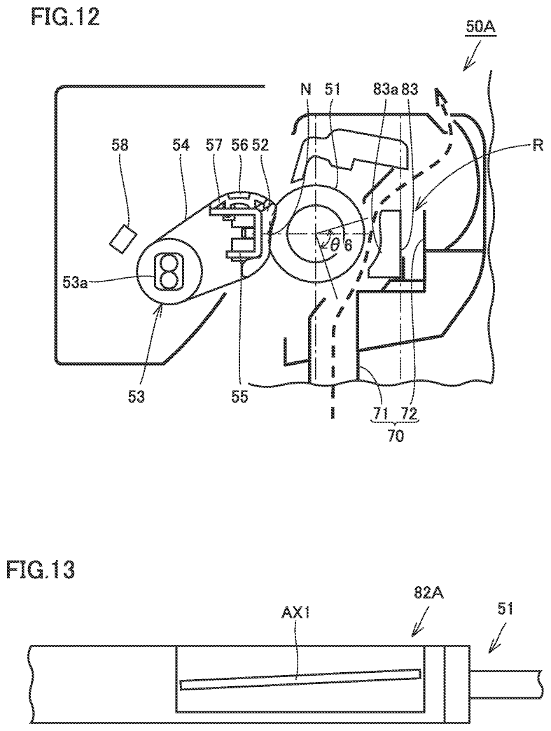

FIG. 11 shows a first state of a fixing device according to Embodiment 2. FIG. 12 shows a second state of the fixing device according to Embodiment 2. A fixing device 50A according to Embodiment 2 will be described with reference to FIGS. 11 and 12.

As shown in FIGS. 11 and 12, fixing device 50A according to Embodiment 2 differs from fixing device 50 according to Embodiment 1 in the configuration of a flow passage adjusting member 80A. The other components are substantially the same.

In Embodiment 2, first swing member 81 is not provided as the flow passage adjusting member, and a swing block 83 is provided as the swing member replacing the second swing member. Also, in first duct portion 71, part of the leading end located on the fixing belt 54 side is inclined toward the central axis of first duct portion 71 as approaching downstream in the air blow direction.

Swing block 83 is disposed in second duct portion 72 and has a facing surface 83a facing part of the circumferential surface of pressure roller 51 in the non-passage area. Facing surface 83a has, for example, a curved shape substantially parallel to the circumferential surface.

Swing block 83 is configured to swing toward or away from pressure roller 51. Specifically, the facing surface moves toward or away from pressure roller 51 while maintaining a state in which the facing surface is parallel to pressure roller 51.

As shown in FIG. 11, in the first state of fixing device 50A, swing block 83 is close to pressure roller 51. In this case, an interval between facing surface 83a and the circumferential surface of pressure roller 51 is small. This can increase the wind velocity of the cooling air passing through between facing surface 83a and the circumferential surface of pressure roller 51. Also, the range of the cooling air flowing along the circumferential surface of pressure roller 51 can be increased.

As shown in FIG. 12, in the second state of fixing device 50A, swing block 83 is far from pressure roller 51. In this case, the interval between facing surface 83a and the circumferential surface of pressure roller 51 is large. This can reduce the wind velocity of the cooling air passing through between facing surface 83a and the circumferential surface of pressure roller 51. Also, the range of the cooling air flowing along the circumferential surface of pressure roller 51 can be reduced. In other words, a central angle θ6 (see FIG. 12) of the circumferential surface of pressure roller 51 along which the cooling air flows in the second state is smaller than a central angle θ5 (see FIG. 11) of the circumferential surface of pressure roller 51 along which the cooling air flows in the first state.

Also in the case of the above configuration, the flow passage through which the cooling air flows can be adjusted with the use of swing block 83 as the flow passage adjusting member, leading to a simple configuration.

Further, since the cooling air is guided to flow between facing surface 83a and pressure roller 51 with facing surface 83a facing the circumferential surface of pressure roller 51, the pressure loss of the cooling air can be reduced more than in the structure in which the cooling air is shielded in the direction orthogonal to the air blow direction, leading to an increased degree of cooling efficiency. Since the range, wind velocity, or the like of the cooling air flowing along the circumferential surface of pressure roller 51 can be adjusted appropriately by adjusting the flow passage, the temperature of the non-passage area can be adjusted.

### Embodiment 3

FIG. 13 shows a second swing member and a pressure roller for a fixing device according to Embodiment 3. The fixing device according to Embodiment 3 will be described with reference to FIG. 13.

As shown in FIG. 13, the fixing device according to Embodiment 3 differs from fixing device 50 according to Embodiment 1 in the configuration of a second swing member 82A. The other components are substantially the same.

Second swing member 82A is not divided and has a shape extending continuously in the direction parallel to the axis of rotation of pressure roller 51. Second swing member 82A has a first end and a second end in the direction parallel to the axis of rotation of pressure roller 51. Second swing member 82A is configured to swing such that portions with different distances to the circumferential surface of the one rotation body are included between the first side end and the second end side.

Specifically, second swing member 82A is provided so as to swing around a shaft AX1 inclined to the direction of the axis of rotation of pressure roller 51. Thus, when the first end side of second swing member 82A moves toward the circumferential surface of pressure roller 51, the second end side of second swing member 82A moves away from the circumferential surface of pressure roller 51. In contrast, when the first end side of second swing member 82A moves away from the circumferential surface of pressure roller 51, the second end side of second swing member 82A moves toward the circumferential surface of pressure roller 51.

Thus, also by swinging second swing member 82A, the air volume of the cooling air can be adjusted such that, in the non-passage area, the air volume of the cooling air cooling the high-temperature area having a higher temperature is larger than the air volume of the cooling air having a temperature lower than that of the high-temperature area.

As described above, the fixing device according to Embodiment 3 can also achieve effects substantially similar to those of Embodiment 1.

### Embodiment 4

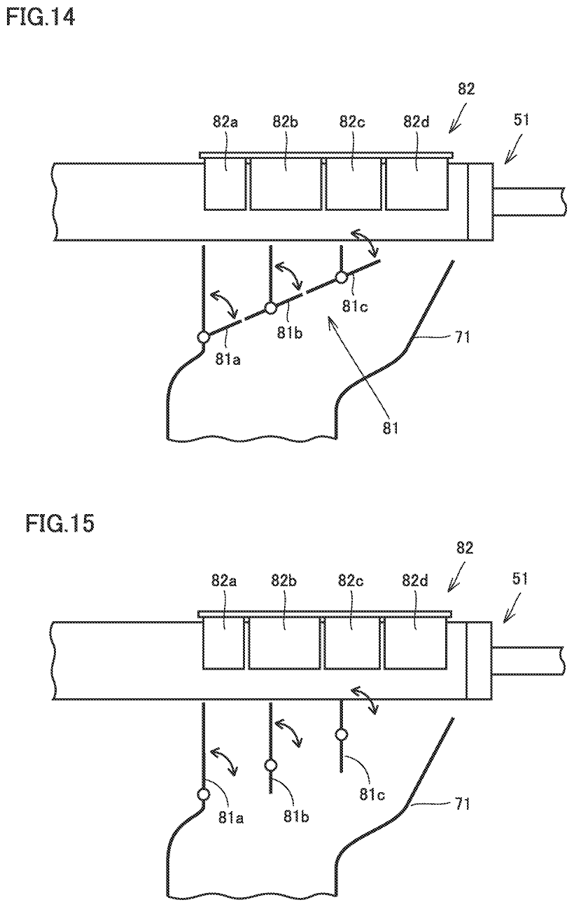

FIG. 14 shows a first state of a fixing device according to Embodiment 4. FIG. 15 shows a second state of the fixing device according to Embodiment 4. The fixing device according to Embodiment 4 will be described with reference to FIGS. 14 and 15.

As shown in FIGS. 14 and 15, the fixing device according to Embodiment 4 differs from fixing device 50 according to Embodiment 1 in the configuration of first swing member 81. The other components are substantially the same.

First swing member 81 has a plurality of divided portions 81a, 81b, and 81c divided in the direction parallel to the axis of rotation of pressure roller 51. Divided portions 81a, 81b, and 81c are each provided to swing independently. Divided portions 81a, 81b, and 81c are configured to swing such that their leading end sides move toward or away from pressure roller 51.

Divided portions 81a, 81b, and 81c divided in the direction parallel to the axis of rotation may have different lengths.

Although Embodiment 4 has described the case in which first swing member 81 has three divided portions by way of example, the number of divided portions may be two, or four or more.

As shown in FIG. 14, in the first state, divided portions 81a, 81b, and 81c are disposed such that their leading end sides are disposed away from pressure roller 51 and are also disposed linearly side by side. Thus, the cooling air is guided toward outside in the direction of the axis of rotation of pressure roller 51 as approaching downstream in the air blow direction.

As shown in FIG. 15, in the second state, divided portions 81a, 81b, and 81c are disposed such that their leading end sides are close to pressure roller 51. This causes divided portions 81a, 81b, and 81c to be substantially parallel to the air blow direction. In this case, the cooling air can be blown to the entire non-passage area of pressure roller 51.

In Embodiment 4, the states that can be assumed by the fixing device are not limited to the first state and the second state, and each of divided portions 81a, 81b, and 81c may be disposed to stop at any swing angle.

The velocity, flow passage, or the like of the cooling air can also be adjusted in the direction parallel to the axis of rotation by adjusting the position of each of divided portions 81a, 81b, and 81c. Thus, the air volume of the cooling air can be adjusted such that, in the high-temperature area, the air volume of the cooling air cooling the high-temperature area having a higher temperature is larger than the air volume of the cooling air cooling the low-temperature area having a temperature lower than that of the high-temperature area.

As described above, the fixing device according to Embodiment 4 can also achieve effects substantially similar to those of Embodiment 1.

Although Embodiments 1 to 4 have described the case in which fan 60 blows cooling air toward pressure roller 51 by way of example, the present invention is not limited thereto. Fan 60 may blow cooling air toward fixing belt 54.

Although Embodiments 1, 3, and 4 have described the case in which flow passage adjusting member 80 includes two swing members, first swing member 81 and second swing member 82, by way of example, the present invention is not limited thereto. Only one swing member may be included, or three or more swing members may be included.

It has been originally intended to combine characteristic portions described in Embodiments 1 to 4 described above.

A fixing device according to the present disclosure described above includes: a fixing rotation body heated by a heat source; a pressure rotation body that comes into pressure contact with the fixing rotation body to form a nip; a fan that blows cooling air toward any one rotation body of the fixing rotation body and the pressure rotation body, a duct that forms a flow area in which the cooling air is flowable so as to cool a non-passage area of a recording medium in the one rotation body; and a movable flow passage adjusting member that is disposed in the flow area and, while guiding the cooling air flowing through the flow area, adjusts a flow passage through which the cooling air flows.

In the fixing device according to the present disclosure, the duct may include a first duct portion for blowing the cooling air toward the non-passage area, and a second duct portion for causing the cooling air blown to the non-passage area to flow such that the cooling air flows along part of a circumference of the one rotation body in the non-passage area. In this case, the flow passage adjusting member is preferably provided in at least any one of the first duct portion and the second duct portion.

In the fixing device according to the present disclosure, the flow passage adjusting member may include a swing member configured to swing toward or away from the one rotation body.

In the fixing device according to the present disclosure, the swing member may include a base end located upstream in an air blow direction in which the cooling air is blown, and a leading end located downstream in the air blow direction. In this case, the swing member may be configured to swing such that a leading end side thereof moves toward or away from the one rotation body.

In the fixing device according to the present disclosure, the swing member may be disposed in the second duct portion and have a facing surface facing part of a circumferential surface of the one rotation body in the non-passage area. In this case, the swing member may be configured to swing such that the facing surface moves toward or away from the one rotation body.

In the fixing device according to the present disclosure, the swing member may extend in a direction parallel to an axis of rotation of the one rotation body. In this case, the swing member may be configured to swing such that portions with different distances to a circumferential surface of the one rotation body are included between a first end side and a second end side of the swing member in the direction parallel to the axis of rotation.

In the fixing device according to the present disclosure, the swing member may have a plurality of divided portions divided in a direction parallel to an axis of rotation of the one rotation body. In this case, the plurality of divided portions may be each provided so as to swing independently.

In the fixing device according to the present disclosure, the plurality of divided portions may have different lengths in the direction parallel to the axis of rotation of the one rotation body.

In the fixing device according to the present disclosure, the non-passage area may include a high-temperature area having a higher temperature, and a low-temperature area having a temperature lower than that of the high-temperature area. In this case, the swing member may be configured to adjust an air volume of the cooling air such that an air volume of the cooling air cooling the high-temperature area is larger than an air volume of the cooling air cooling the low-temperature area.

The fixing device according to the present disclosure may further include a controller that controls an operation of the flow passage adjusting member. The controller preferably controls the operation of the flow passage adjusting member based on information on the recording medium, the information including at least a size of the recording medium.

An image forming apparatus according to the present disclosure includes an image forming device that forms a toner image on a recording medium transported along a transport path, and the fixing device that fixes the toner image onto the recording medium transported along the transport path.

Although embodiments of the present invention have been described and illustrated in detail, the disclosed embodiments are made for purposes of illustration and example only and not limitation. The scope of the present invention should be interpreted by terms of the appended claims.

What is claimed is:

1. A fixing device comprising:
a fixing rotation body heated by a heat source;
a pressure rotation body that comes into pressure contact with the fixing rotation body to form a nip;
a fan that blows cooling air toward any one rotation body of the fixing rotation body and the pressure rotation body;
a duct that forms a flow area in which the cooling air is flowable so as to cool a non-passage area of a recording medium in the one rotation body; and
a movable flow passage adjusting member that is disposed in the flow area and adjusts a flow passage through which the cooling air flowing through the flow area flows while guiding the cooling air.

2. The fixing device according to claim 1, wherein
the duct includes
a first duct portion for blowing the cooling air toward the non-passage area, and
a second duct portion for causing the cooling air blown to the non-passage area to flow such that the cooling air flows along part of a circumference of the one rotation body in the non-passage area, and
the flow passage adjusting member is provided in at least any one of the first duct portion and the second duct portion.

3. The fixing device according to claim 2, wherein the flow passage adjusting member includes a swing member configured to swing toward or away from the one rotation body.

4. The fixing device according to claim 3, wherein
the swing member includes
a base end located upstream in an air blow direction in which the cooling air is blown, and
a leading end located downstream in the air blow direction, and
the swing member is configured to swing such that a leading end side thereof moves toward or away from the one rotation body.

5. The fixing device according to claim 3, wherein
the swing member is disposed in the second duct portion and has a facing surface facing part of a circumferential surface of the one rotation body in the non-passage area, and
the swing member is configured to swing such that the facing surface moves toward or away from the one rotation body.

6. The fixing device according to claim 3, wherein
the swing member extends in a direction parallel to an axis of rotation of the one rotation body, and
the swing member is configured to swing such that portions with different distances to a circumferential surface of the one rotation body are included between a first end side and a second end side of the swing member in the direction parallel to the axis of rotation.

7. The fixing device according to claim 3, wherein
the swing member has a plurality of divided portions divided in a direction parallel to an axis of rotation of the one rotation body, and
the plurality of divided portions are each provided so as to swing independently.

8. The fixing device according to claim 7, wherein the plurality of divided portions have different lengths in the direction parallel to the axis of rotation.

9. The fixing device according to claim 3, wherein
the non-passage area includes
a high-temperature area having a higher temperature, and
a low-temperature area having a temperature lower than that of the high-temperature area, and
the swing member is configured to adjust an air volume of the cooling air such that an air volume of the cooling air cooling the high-temperature area is greater than an air volume of the cooling air cooling the low-temperature area.

10. The fixing device according to claim 1, further comprising a controller that controls an operation of the flow passage adjusting member,
wherein the controller controls the operation of the flow passage adjusting member based on information on the recording medium, the information including at least a size of the recording medium.

11. An image forming apparatus comprising:
an image forming device that forms a toner image on a recording medium transported along a transport path; and
a fixing device according to claim 1 that fixes the toner image onto the recording medium transported along the transport path.
